(19) United States
(12) Patent Application Publication
(10) Pub. No.: US 2022/0113012 A1
(43) Pub. Date: Apr. 14, 2022

(54) LAMP INSTALLATION CONSTRUCTION AND A LAMP

(71) Applicant: NINGBO VEALITE ILLUMINATION CO., LTD, Ningbo City (CN)

(72) Inventor: Maoyin ZHANG, Ningbo City (CN)

(21) Appl. No.: 17/097,721

(22) Filed: Nov. 13, 2020

(30) Foreign Application Priority Data
Oct. 14, 2020 (CN) 202022288252.2

(51) Int. Cl. F21V 21/35; H01R 33/06; H01R 33/46; H01R 13/627

(52) U.S. Cl. CPC F21V 21/35; H01R 13/6278; H01R 33/46; H01R 33/06

(57) ABSTRACT

This utility design discloses a lamp body installation structure, which comprises a structure main body and a lamp cap electrode arranged on the structure main body. An elastic pin is arranged in the main body of the structure, and the elastic pin can be penetrated out from the inside of the structure main body. The utility design also comprises a toggle rod, the elastic pin can move axially under the action of the toggle rod. A lamp with a lamp body mounting structure is also disclosed. Compared with the prior art, advantage of the utility design is that the application adds a limit column, a spring and other matching structures, which can realize the fixation of the utility model at the lower limit of the spring force when the utility model is connected with the GU24 lamp holder during the installation, so as to realize its stable installation.

### TECHNICAL FIELD

The utility design relates to the field of lighting devices, in particular to a lamp body installation structure and a lamp.

### BACKGROUND TECHNOLOGY

GU24 is a traditional lighting structure. The two electrodes of the traditional GU24 lamp extend to the outside. There are round holes on the GU24 lamp holder, as shown in FIG. 1. When installing, align the electrode with the round hole of the lamp holder, insert it to the bottom, and then rotate to realize the installation of the lamp. However, this installation method is not stable enough, which is easy to loose, which will cause the bulb to fall off and the lamp cannot work normally Therefore, it is very important to obtain a stable lamp body mounting structure and a lamp with the lamp body mounting structure.

Contents of Utility

In order to solve the above technical problems, on the one hand, the utility model provides a lamp body installation structure, which includes a structure main body and a lamp cap electrode arranged on the structure main body, and the elastic pin is arranged in the main body of the structure, and the elastic pin can penetrate through the inner and outer parts of the structure body. The utility model also includes a toggle rod connected with an elastic pin, which is arranged on the side of the main body of the structure, and the elastic pin can move axially under the action of the toggle rod. The top of the main body of the structure is provided with a limit hole for the elastic pin to pass through, and the side surface of the main body of the structure is provided with a guide groove for the pulling rod to pass through. A positioning column matched with the elastic pin is arranged in the main body of the structure. The spring sleeve is arranged at the bottom of the limit column, and the bottom end of the spring is placed in the positioning column. Under the action of the toggle rod, the bottom of the limit column moves axially within the height range of the positioning column. The limiting column and the toggle rod are integrated.

On the other hand, the utility model also provides a lamp including the lamp body mounting structure, wherein the lamp also includes a first shell for light transmission and a second shell connecting the main body of the structure and the first shell. The top of the structure main body is provided with a limit hole for the elastic pin to pass through, and the positioning column is integrally formed on the upper surface of the second shell.

The top of the main body of the structure is downward provided with a connecting column, the first shell and the second shell are provided with screw holes, and the three parts are connected and fixed with the connecting column through the screws. A heat sink is integrally formed on the third shell.

Compared with the prior art, the utility model has the following advantages: the application adds a limit column, a spring and other accessory structures, which can realize the fixation of the utility model at the lower limit of the spring force when the utility model is connected with the GU24 lamp holder during the installation, so as to realize the stable installation of the utility model.

### DESCRIPTION OF DRAWINGS

FIG. 1 shows the structure of GU24 lamp holder;

FIG. 2 is a stereogram of the utility model:

FIG. 3 is a section diagram of the utility model;

FIG. 4 is the structural diagram of the utility model connecting GU24 lamp holder.

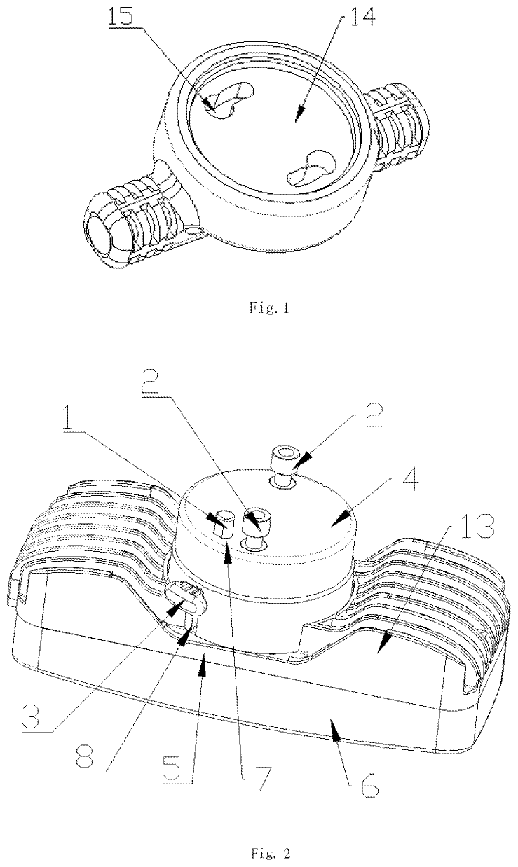

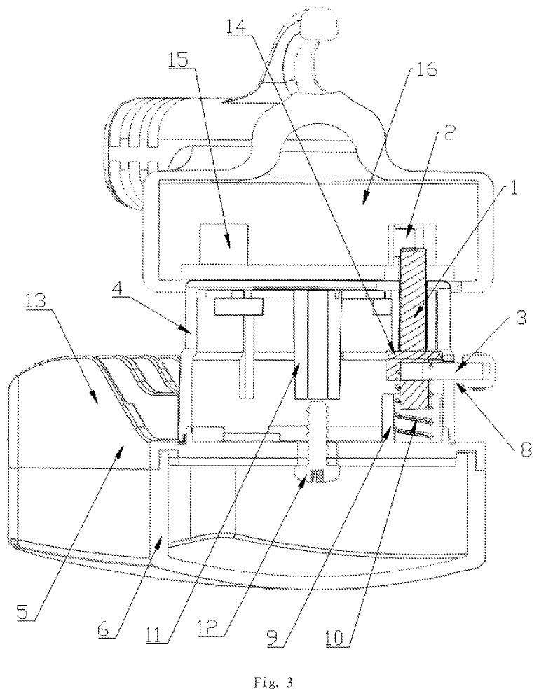

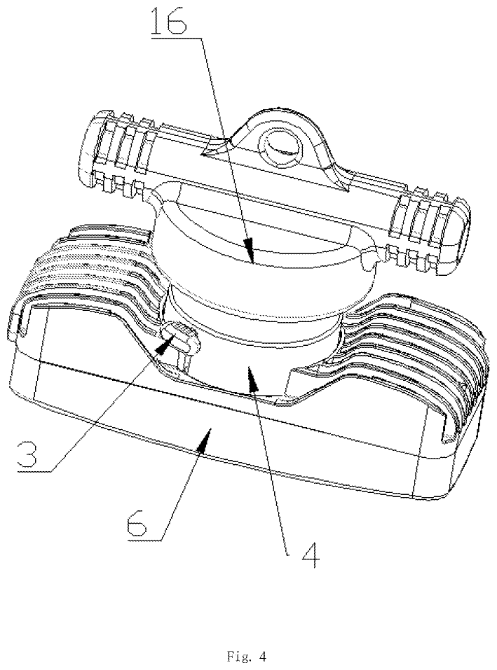

Figure marks: 1—limit column; 2—Lamp cap electrode; 3—toggle rod; 4—main structure; 5—second shell; 6—first shell; 7—limit hole; 8—guide groove; 9—positioning column; 10—spring; 11—connecting column; 12—screw; 13—radiator; 14—limit ring; 15—round hole; 16—gu24 lamp holder.

Specific Implementation Mode

In order to make the technical personnel in the field better understand the utility model, so as to define the scope of protection required by the utility model more clearly, the utility model is described in detail below with respect to some specific embodiments of the utility model. It should be noted that the following are only some specific implementation modes of the utility model, which are only part of the implementation examples of the utility model. The specific and direct description of the relevant structure is only for the convenience of understanding the utility model, and the specific features do not naturally and directly limit the implementation scope of the utility model.

Referring to the attached drawings, the utility model adopts the following technical solutions. On the one hand, the utility model provides a lamp body installation structure, which includes a structure main body and a lamp cap electrode fixed on the top of the structure main body, and an elastic pin is arranged in the main body of the structure, and the elastic pin can penetrate out of the main body of the structure. The utility model also includes a toggle rod connected with an elastic pin, which is arranged on the side of the main body of the structure, and the elastic pin can move axially under the action of the toggle rod.

The top of the main body of the structure is provided with a limit hole for the elastic pin to pass through, and the side surface of the main body of the structure is provided with a guide groove for the pulling rod to pass through. A positioning column matched with the elastic pin is arranged in the main body of the structure. The spring sleeve is arranged at the bottom of the limit column, and the bottom end of the spring is placed in the positioning column. Under the action of the toggle rod, the bottom of the limit column moves axially within the height range of the positioning column, and the toggle rod can be moved up and down in the guide groove. There is a certain angle between the limit column and the toggle rod, which is preferably set vertically. The limit column and the toggle rod are integrated into the shape, or there is a groove in the limit column, and the toggle rod is inserted into the groove to lock the limit in the groove.

On the other hand, the utility model also provides a lamp including the lamp body mounting structure, wherein the lamp also includes a first shell for light transmission and a second shell connecting the main body of the structure and the first shell. The top of the structure main body is provided with a limit hole for the elastic pin to pass through, and the positioning column is integrally formed on the upper surface of the second shell. A cavity formed between the first housing and the second housing is used to place a lamp bead for emitting light of the existing GU24 lamp and a connecting line thereof. The limiting column is also integrally formed with a finite ring, which can prevent the limit column from penetrating through the limit hole.

The top of the structure main body is downward provided with a connecting column, the first shell and the second shell are provided with screw holes, and the three parts are connected and fixed with the connecting column through the screws. Among them, the structure body, the first shell and the second shell are fixedly connected, which is not limited to the above method of fixing with screws. A heat sink is integrally formed on the second shell.

The application adds a limit column, a spring and other accessory structures, which can realize the limit fixation under the spring force when the utility model is connected with the GU24 lamp holder during the installation, so as to realize the stable installation of the utility model.

When the utility model needs to be taken out, press the toggle rod to make the limit column move downward, so that the limit column is separated from the GU24 lamp holder, and the whole lamp body is rotated and pulled out to realize the separation of the utility model and GU24 lamp holder.

The above description does not limit the utility model, and the utility model is not limited to the above examples. The changes, modifications, additions or substitutions made by technicians in the technical field within the substantive scope of the utility model also belong to the protection scope of the utility model.

1. A lamp body installation structure includes a structure main body and a lamp cap electrode arranged on the structure main body, wherein an elastic pin is arranged in the structure main body, and the elastic pin can pass through the structure main body from the inside out.

2. The lighting structure according to claim 1, wherein: it also includes a toggle rod which is connected with an elastic pin. The toggle rod is arranged on the side of the structure main body, and the elastic pin can move axially under the action of the toggle rod.

3. The lamp structure according to claim 2, wherein the top of the structure main body is provided with a limit hole for the elastic pin to pass through, and the side surface of the structure main body is provided with a guide groove for the pulling rod to penetrate.

4. The lamp structure according to claim 2, wherein a positioning column matched with an elastic pin is arranged in the main body of the structure.

5. The lamp structure according to claim 4, wherein the elastic pin comprises a limit column and a spring, the spring is set at the bottom of the limit column, and the bottom end of the spring is placed in the positioning column.

6. The lamp structure according to claim 4, wherein the bottom of the limiting column moves axially within the height range of the positioning column under the action of the toggle rod.

7. The lamp structure according to claim 5, wherein the bottom of the limiting column moves axially within the height range of the positioning column under the action of the toggle rod.

8. The lamp structure according to claim 5, wherein the limiting column and the toggle rod are integrally formed.

9. A lamp, wherein the lamp body mounting structure according to claim 1 is included.
